(19) United States
(12) Patent Application Publication
(10) Pub. No.: US 2024/0268468 A1
(43) Pub. Date: Aug. 15, 2024

(54) AEROSOL GENERATING DEVICE

(71) Applicant: Nicoventures Trading Limited, London (GB)

(72) Inventors: Benjamin TAYLOR, London (GB); Dean COWAN, London (GB); Matthew HODGSON, London (GB)

(21) Appl. No.: 18/568,980

(22) PCT Filed: Jun. 17, 2022
(86) PCT No.: PCT/EP2022/066612

§ 371 Date: Dec. 11, 2023

(30) Foreign Application Priority Data
Jun. 18, 2021 (GB) 2108765.5

(51) Int. Cl. A24F 40/465

(52) U.S. Cl. CPC A24F 40/465

(57) ABSTRACT

An aerosol generating device (101) is described. The device is for generating an aerosol from aerosol-generating material. The device has a heating zone (215) for receiving at least a portion of an article (110) comprising aerosol-generating material and a heating assembly (201). The heating assembly comprises a magnetic field generator (240) to generate a varying magnetic field including an inductor coil (242) and a heating element (220) comprising heating material that is heatable by penetration with the varying magnetic field. The heating element protrudes in the heating zone and the inductor coil at least partially protrudes in the heating zone.

### RELATED APPLICATIONS

The present application is a National Phase entry of PCT Application No. PCT/EP2022/066612 filed Jun. 17, 2022, which claims priority to GB Application No. 2108765.5 filed Jun. 18, 2021, each of which is hereby incorporated by reference in their entirety.

### TECHNICAL FIELD

The present invention relates to aerosol generating devices for generating an aerosol from aerosol-generating material. The present invention also relates to a system comprising an aerosol generating device, a heating assembly for an aerosol generating device, and an article comprising aerosol-generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example smoking material.

### SUMMARY

According to an aspect, there is provided an aerosol generating device for generating an aerosol from aerosol-generating material. The device comprises a heating zone for receiving at least a portion of an article comprising aerosol-generating material and a heating assembly comprising a magnetic field generator configured to generate a varying magnetic field including an inductor coil and a heating element comprising heating material that is heatable by penetration with the varying magnetic field. The heating element protrudes in the heating zone and the inductor coil at least partially protrudes in the heating zone.

The inductor coil may at least partially extend in the heating element.

The inductor coil may be fluidly isolated from the heating zone.

The heating element may comprise a cavity and the inductor coil may at least partially extend in the cavity.

The cavity may be isolated from the heating zone.

The cavity may at least partially define an air path through the heating element.

The heating element may comprise a wall and an air outlet communicating through the wall.

The heating element may comprise a heating member and an insulator in the heating member.

The insulator may support the inductor coil in the heating member.

The insulator may comprise a filler.

The filler may fill the cavity.

The filler may be a non-conductive material.

The filler may be a thermal putty.

The coil may comprise a coating.

The insulator may electrically insulate the coil from the heating member.

The aerosol generating device of any of claims 4 to 12, wherein the heating material is spaced from the inductor coil.

A distance between the inductor coil and the heating member may be between 0.1 to 0.2 mm.

The inductor coil may be spaced from the heating material by a distance less than 0.2 mm.

The inductor coil may be spaced from the heating material by a distance between 0.1 to 0.2 mm.

The inductor coil may be a helical coil.

The internal diameter of the inductor coil may be between 1 mm and 1.5 mm.

The outer diameter of the inductor coil may be between 2 mm and 2.5 mm.

The heating element may be tubular.

The heating element may be a blade.

The inductor coil may comprise a coil winding having a cross-sectional diameter between 0.5 mm and 0.75 mm.

The magnetic field generator may be configured to generate a varying magnetic field at a frequency of from 800 kHz to 1.5 MHz.

The inner diameter of the heating element may be from 2.5 mm to 3 mm.

The outer diameter of the heating element may be from 3.3 mm to 3.8 mm.

According to an aspect, there is provided an aerosol generating device for generating an aerosol from aerosol-generating material. The device comprises a receptacle for receiving at least a portion of an article comprising aerosol-generating material and a heating assembly comprising a magnetic field generator configured to generate a varying magnetic field including an inductor coil and a heating element that is heatable by penetration with the varying magnetic field. At least a portion of the inductor coil and the heating element protrudes in the receptacle.

According to an aspect, there is provided an aerosol generating device for generating an aerosol from aerosol-generating material. The device comprises a receptacle for receiving at least a portion of an article comprising aerosol-generating material and a heating assembly comprising a magnetic field generator configured to generate a varying magnetic field including an inductor coil and a heating element that is heatable by penetration with the varying magnetic field. A spacing between the heating element and the inductor coil is less than 0.2 mm.

According to an aspect, there is provided a heating assembly for an aerosol generating device comprising: an inductor coil for a magnetic field generator configured to generate a varying magnetic field; and a heating element arranged to extend in a heating zone of an aerosol generating device, the heating element comprising heating material that is heatable by penetration with the varying magnetic field; wherein the inductor coil at least partially extends in the heating element.

According to an aspect, there is provided a system comprising the aerosol generating device as described above and further comprising an article comprising aerosol-generating material.

The article may be free from material heatable by penetration with the varying magnetic field.

The article may be a consumable.

The heating element may be removable from the heating zone. The heating element may be interchangeable.

The heating element and receptacle may be co-axial.

The device of this aspect can include one or more, or all, of the features described above, as appropriate.

The aerosol generating device may be a non-combustible aerosol generating device.

The device may be a tobacco heating device, also known as a heat-not-burn device.

The aerosol generating material may be non-liquid aerosol generating material.

The article may be dimensioned to be at least partially received within the heating zone.

According to an aspect, there is provided an aerosol generating device for generating an aerosol from aerosol-generating material comprising: a receptacle defining a heating zone configured to receive at least a portion of an article comprising aerosol-generating material, and a heating element arranged to heat the heating zone.

According to an aspect, there is provided an aerosol-generating system comprising an article comprising aerosol-generating material; an aerosol generating device for heating aerosol-generating material comprising a heating zone configured to receive at least a portion of the article; and a heating element.

According to an aspect, there is provided an aerosol generating device for generating an aerosol from aerosol-generating material, the device comprising: a heating assembly comprising: a magnetic field generator configured to generate a varying magnetic field including an inductor coil; and a heating element comprising heating material that is heatable by penetration with the varying magnetic field; wherein the inductor coil at least partially protrudes in the heating element.

According to an aspect, there is provided an aerosol provision system comprising: the aerosol generating device of the preceding aspect; and an aerosol generating article.

The aerosol generating article may comprise a bore configured to receive the heating arrangement.

According to an aspect, there is provided a method of use of the device of the preceding aspect to generate an aerosol from an aerosol-generating article.

The method may comprise inserting the heating arrangement into the aerosol-generating article.

According to an aspect, there is provided an aerosol generating device for generating an aerosol from aerosol-generating material, the device comprising: a heating assembly comprising: a magnetic field generator configured to generate a varying magnetic field including an inductor coil; and a heating element that is heatable by penetration with the varying magnetic field; wherein a spacing between the heating element and the inductor coil is less than 0.2 mm.

According to an aspect, there is provided an aerosol provision system comprising: the aerosol generating device of the preceding aspect; and an aerosol generating article.

The aerosol generating article may comprise a bore configured to receive the heating arrangement.

According to an aspect, there is provided a method of use of the device of the preceding aspect to generate an aerosol from an aerosol-generating article.

The method may comprise inserting the heating arrangement into the aerosol-generating article.

According to an aspect, there is provided a heating assembly for an aerosol generating device, the assembly comprising: an inductor coil for a magnetic field generator configured to generate a varying magnetic field; and a heating element, the heating element comprising heating material that is heatable by penetration with the varying magnetic field; wherein the inductor coil at least partially extends in the heating element.

According to an aspect, there is provided an aerosol provision system comprising: the aerosol generating device of the preceding aspect; and an aerosol generating article.

The aerosol generating article may comprise a bore configured to receive the heating arrangement.

According to an aspect, there is provided a method of use of the device of the preceding aspect to generate an aerosol from an aerosol-generating article.

The method may comprise inserting the heating arrangement into the aerosol-generating article.

According to an aspect, there is provided an aerosol generating device for generating an aerosol from aerosol-generating material, the device comprising: a housing; an exposed heating arrangement protruding from the housing configured to be received within an aerosol-generating article and heat the aerosol-generating article.

The heating arrangement may comprise a heating element protruding from the housing configured to be received within an aerosol-generating article.

The housing may comprise a base from which the heating element protrudes.

The heating arrangement may comprise a protruding element protruding from the housing configured to be received within an aerosol-generating article.

The housing may comprise a base from which the protruding element protrudes.

The heating arrangement may be a resistive heating arrangement.

The heating arrangement may be an inductive heating arrangement.

The heating arrangement may comprise an inductor coil.

A heating zone may extend around the exposed heating arrangement. The heating zone may be configured to at least partially receive the article comprising aerosol-generating material.

According to an aspect, there is provided an aerosol provision system comprising: the aerosol generating device of the preceding aspect; and an aerosol generating article.

The aerosol generating article may comprise a bore configured to receive the heating arrangement.

The aerosol generating article may comprise a heating element. The heating element may comprise a material which is heatable by penetration with a varying magnetic field.

According to an aspect, there is provided a method of use of the device of the preceding aspect to generate an aerosol from an aerosol-generating article.

The method may comprise inserting the heating arrangement into the aerosol-generating article.

The device of these aspects can include one or more, or all, of the features described above, as appropriate.

### BRIEF DESCRIPTION OF THE DRAWINGS

Embodiments will now be described, by way of example only, and with reference to the accompanying drawings in which:

FIG. 1 shows a front perspective view of an aerosol generating system with an aerosol generating device and an article inserted into the device;

FIG. 2 shows schematically the aerosol generating system of FIG. 1;

FIG. 3 shows schematically a heating arrangement of the aerosol generating system of FIG. 1;

FIG. 4 shows schematically another heating arrangement of the aerosol generating system of FIG. 1 wherein the heating member comprises a cavity in which the inductor coil is positioned;

FIG. 5 shows schematically another heating arrangement of FIG. 4 further including an insulator placed in the cavity;

FIG. 6 shows schematically another heating arrangement of FIG. 5, with the insulator filling the cavity;

FIG. 7 shows schematically another heating arrangement of FIGS. 4 to 6, with an air inlet and outlet provided in the heating member;

FIG. 8 shows schematically another aerosol generating system; and

FIG. 9 shows schematically another aerosol generating system.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol generating material may include any botanical material, such as any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

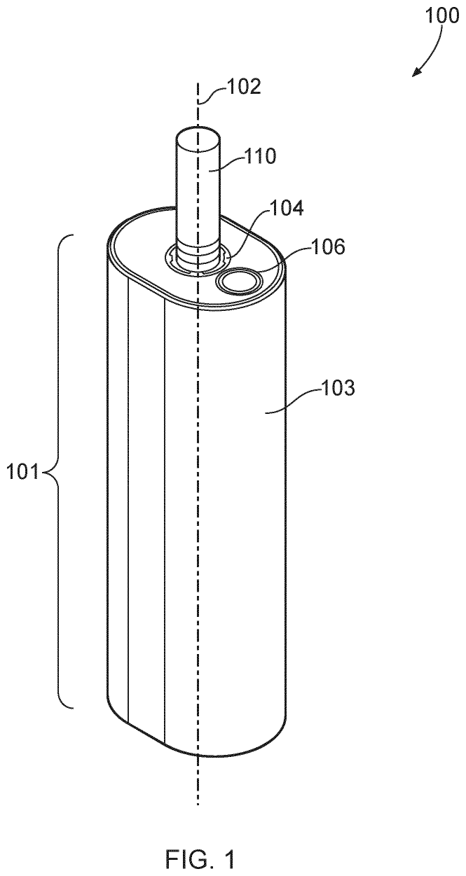

FIG. 1 shows an example of an aerosol generating system 100. The system 100 comprises an aerosol generating device 101 for generating aerosol from an aerosol generating material, and a replaceable article 110 comprising the aerosol-generating material. The device 101 can be used to heat the replaceable article 110 comprising the aerosol-generating material, to generate an aerosol or other inhalable material which can be inhaled by a user of the device 101.

The device 101 comprises a housing 103 which surrounds and houses various components of the device 101. The housing 103 is elongate. The device 101 has an opening 104 in one end, through which the article 110 can be inserted for heating by the device 101. The article 110 may be fully or partially inserted into the device 101 for heating by the device 101.

In various embodiments, the device 101 is free from an opening. In such an arrangement, the device 101, or a component thereof, may be partially received within at least a portion of the article 110.

The device 101 may comprise a user-operable control element 106, such as a button or switch, which operates the device 101 when operated, e.g. pressed. For example, a user may activate the device 101 by pressing the switch 106.

The device 101 defines a longitudinal axis 102, along which an article 110 may extend when inserted into the device 101. The opening 104 is aligned on the longitudinal axis 102.

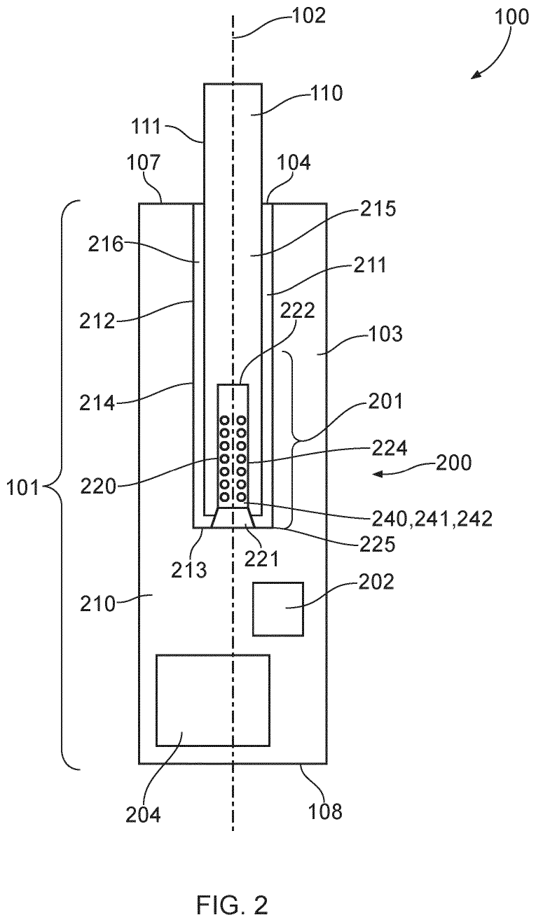

FIG. 2 is a schematic illustration of the aerosol generating system 100 of FIG. 1, showing various components of the device 101. It will be appreciated that the device 101 may include other components not shown in FIG. 2 or may not include some of the components shown in FIG. 2.

As shown in FIG. 2, the device 101 includes an apparatus 200 for heating aerosol-generating material. The apparatus 200 includes a heating assembly 201, a controller (control circuit) 202, and a power source 204. The apparatus 200 comprises a body assembly 210. The body assembly 210 may include a chassis and other components forming part of the device. The heating assembly 201 is configured to heat the aerosol-generating medium or material of an article 110 inserted into the device 101, such that an aerosol is generated from the aerosol-generating material. The power source 204 supplies electrical power to the heating assembly 201, and the heating assembly 201 converts the supplied electrical energy into heat energy for heating the aerosol-generating material.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source 204 may be electrically coupled to the heating assembly 201 to supply electrical power when required and under control of the controller 202 to heat the aerosol generating material. The control circuit 202 may be configured to activate and deactivate the heating assembly 201 based on a user operating the control element 106. For example, the controller 202 may activate the heating assembly 201 in response to a user operating the switch 106.

The end of the device 101 closest to the opening 104 may be known as the proximal end (or mouth end) 107 of the device 101 because, in use, it is closest to the mouth of the user. In use, a user inserts an article 110 into the opening 104, operates the user control 106 to begin heating the aerosol generating material and draws on the aerosol generated in the device. This causes the aerosol to flow through the article 110 along a flow path towards the proximal end of the device 101.

The other end of the device furthest away from the opening 104 may be known as the distal end 108 of the device 101 because, in use, it is the end furthest away from the mouth of the user. As a user draws on the aerosol generated in the device, the aerosol flows in a direction towards the proximal end of the device 101. The terms proximal and distal as applied to features of the device 101 will be described by reference to the relative positioning of such features with respect to each other in a proximal-distal direction along the axis 102.

The heating assembly 201 may comprise various components to heat the aerosol generating material of the article 110 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field.

The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The apparatus 200 includes a heating chamber 211 configured and dimensioned to receive the article 110 to be heated. The heating chamber 211 defines a heating zone 215. In the present example, the article 110 is generally cylindrical, and the heating chamber 211 is correspondingly generally cylindrical in shape. However, other shapes would be possible. The heating chamber 211 is formed by a receptacle 212. The receptacle 212 includes an end wall 213 and a peripheral wall 214. The end wall 213 acts as a base of the receptacle 212. The receptacle 212 in embodiments is a one-piece component. As used herein, the term ‘one-piece component’ is intended to mean that the features are formed together such that no joints are defined therebetween. In other embodiments the receptacle comprises two or more components.

The heating chamber 211 is defined by the inner surfaces of the receptacle 212. The receptacle 212 acts as a support member. The receptacle 212 comprises a generally tubular member. The receptacle 212 extends along and around and substantially coaxial with the longitudinal axis 102 of the device 101. However, other shapes would be possible. The receptacle 212 (and so heating zone 215) is open at its proximal end such that an article 110 inserted into the opening 104 of the device 101 can be received by the heating chamber 211 therethrough. The receptacle 212 is closed at its distal end by the end wall 213. The receptacle 212 may comprise one or more conduits that form part of an air path. In use, the distal end of the article 110 may be positioned in proximity or engagement with the end of the heating chamber 211. Air may pass through the one or more conduits forming part of the air path, into the heating chamber 211, and flow through the article 110 towards the proximal end of the device 101.

The receptacle 212 is formed free of material that is heatable by penetration with a varying magnetic field. The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 101. The receptacle 212 may be formed from a rigid material to aid support of other components.

Other arrangements for the receptacle 212 would be possible. For example, in an embodiment the end wall 213 is defined by part of the heating assembly 201. In embodiments, the receptacle 212 comprises material that is heatable by penetration with a varying magnetic field.

As illustrated in FIG. 2, the heating assembly 201 comprises a heating element 220. The heating element 220 is configured to heat the heating zone 215. The heating zone 215 is defined in the heating chamber 211. In embodiments the heating chamber 211 defines a portion of the heating zone 215 or the extent of the heating zone 215.

The heating zone 215 is a zone or volume into which an article may be received for heating by the device 101. The heating zone 215 is defined therefore at least in part by the heating assembly 201. The heating zone 215 is a space adjacent to the heating element 220. In embodiments comprising the heating chamber 211, such as shown in FIG. 2, the heating chamber 211 delimits the heating zone 215. That is, the heating chamber defines the heating zone 215. In embodiments, the heating element 220 defines the heating zone.

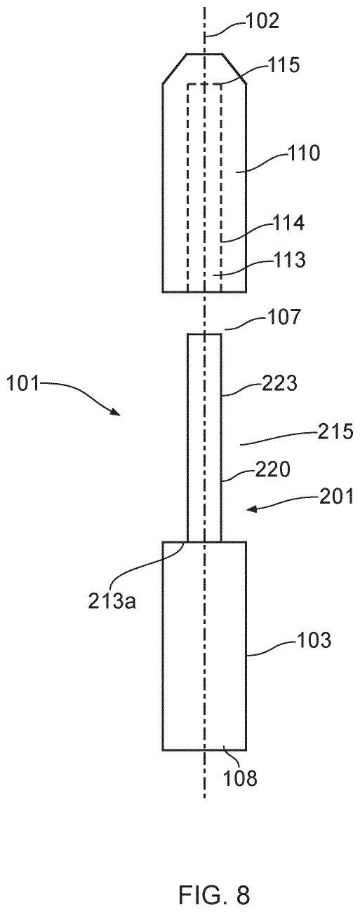

As illustrated in FIG. 8, in various embodiments the apparatus is free from a heating chamber. The device 101 comprises a protruding element protruding from the housing. The protruding element comprises the heating element. In such embodiments, the receptacle and heating chamber may be omitted, and the protruding element may be surrounded by free space. The protruding element, or at least part of the protruding element, is free from being surrounded by a peripheral member, such as a peripheral wall of the device when the article is on the protruding element. The term ‘heating zone’ will be understood to include a space surrounding the protruding element. That is, the heating zone may not be delimited or surrounded by a component of the device 101.

The heating element 220 is heatable to heat the heating zone 215. The heating element 220 is an induction heating element. That is, the heating element 220 comprises a susceptor that is heatable by penetration with a varying magnetic field. In embodiments, the device 101 does not comprise a susceptor, and the susceptor is provided in the article 110. In embodiments, the heating element is a resistive heating element. The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The heating assembly 201 comprises a magnetic field generator 240. The magnetic field generator 240 is configured to generate one or more varying magnetic fields that penetrate the heating element 220 so as to cause heating in the heating element 220. The magnetic field generator 240 includes an inductor coil arrangement 241. The inductor coil arrangement 241 comprises an inductor coil 242, acting as an inductor element. The inductor coil 242 is a helical coil, however other arrangements are envisaged. In embodiments, the inductor coil arrangement 241 may comprise two or more inductor coils 242. The two or more inductor coils in embodiments may be disposed adjacent to each other and may be aligned co-axially along the axis. The inductor coil arrangement 241 is disposed in the heating element 220 as will be described below.

In some examples, in use, the inductor coil is configured to heat the heating element 220 to a temperature of between about 200° C. and about 350° C., such as between about 240° C. and about 300° C., or between about 250° C. and about 280° C.

In embodiments, the heating element forms part of a heating arrangement. The heating arrangement comprises the heating element protruding from the base. In other embodiments, the heating element is in the article, and the heating arrangement comprises a protruding member protruding from the base. The heating element or protruding member in embodiments comprises the magnetic field generator configured to generate a varying magnetic field including an inductor coil. The heating arrangement in embodiments is an inductive heating arrangement. The heating arrangement in embodiments is a resistive heating arrangement.

The heating element 220 extends in the heating zone 215. The heating element 220, acting as a protruding element, protrudes in the heating zone 215. The heating element 220 upstands from the base. The heating element 220 is spaced from the peripheral wall 214. The heating assembly 201 is configured such that when an article 110 is received by the heating chamber 211, the heating element 220 extends into a distal end of the article 110. The heating element 220 is positioned, in use, within the article 110. The heating element 220 is configured to heat aerosol generating material of an article 110 from within, and for this reason is referred to as an inner heating element.

In embodiments, the base is formed by a feature other than the end wall 213 of the receptacle.

The heating element 220 extends into the heating chamber 211 from the distal end of the heating chamber 211 along the longitudinal axis 102 of the device (in the axial direction). In embodiments the heating element 220 extends into the heating chamber 211 spaced from the axis 102. The heating element 220 may be off-axis or non-parallel to the axis 102. Although one heating element 220 is shown, it will be understood that in embodiments, the heating assembly 201 comprises a plurality of heating elements 220. Such heating elements in embodiments are spaced from but parallel to each other.

The inductor coil 241 may be a helical coil comprising electrically-conductive material, such as copper. The coil is formed from wire, such as Litz wire, which is wound helically around a support member. In embodiments, the support member is omitted. The support member is tubular. The coil 241 defines a generally tubular shape. The inductor coil 241 has a generally circular profile. In other embodiments, the inductor coil 241 may have a different shape, such as generally square, rectangular or elliptical. The coil width may increase or decrease along its length.

Other types of inductor coil may be used, for example a flat spiral coil.

Litz wire comprises a plurality of individual wires which are individually insulated and are twisted together to form a single wire. Litz wires are designed to reduce the skin effect losses in a conductor. Other wire types could be used, such as solid. The configuration of the helical inductor coil may vary along its axial length. For example, the inductor coil, or each inductor coil, may have substantially the same or different values of inductance, axial lengths, radii, pitches, numbers of turns, etc.

The heating element 220 protrudes in the heating zone 215 and is received by the article 110. FIG. 2 shows the article 110 received in the device 101. The article 110 is sized to be received by the receptacle 212. The outer dimensions of the article 110 perpendicular to the longitudinal axis of the article 110 substantially correspond with the inner dimensions of the chamber 211 perpendicular to the longitudinal axis 102 of the device 101 to allow insertion of the article 110 into the receptacle 212. In embodiments, a gap 216 is defined between an outer side 111 of the article 110 and an inner side 217 of the receptacle 212. The gap 216 may act as an air passage along at least part of the axial length of the chamber 211. An insertion end 112 of the article 110 is arranged to lie adjacent to the base of the receptacle 212.

The heating element 220 extends in the heating zone 215 from the distal end of the receptacle 212. The heating element 220 upstands from the end wall 213. The heating element 220 comprises a heating member 224. The heating member 224 is elongate. The heating element 220 comprises a base end 221 and an opposing free end 222. The heating member 224 is a pin or column. Other shapes are envisaged, for example the heating member 224 in embodiments is a blade. The heating member 224 upstands from a collar 225. The collar may act as a seal to seal with an end of the article 110. The collar 225 may be omitted.

The heating element 220 comprises an outer surface 223. The outer surface 223 defines a periphery of the heating element 220. The outer surface 223 extends between the base end 221 and the free end 222. The heating element 220 is generally cylindrical although other shapes are envisaged.

The article 110 comprises a bore 113. The bore 113 is pre-formed in the article 110. The bore 113 is formed in embodiments by a tubular portion of the article 110. The bore 113 in embodiments extends partially along the longitudinal axis of the article. The bore 113 comprises an inner surface 114. The bore 113 has a closed end 115. The heating member 224 is sized to be received in the bore 113. The heating member 224 and bore 113 are complimentary sized to form a slide fit. The inner surface 114 of the bore is configured to form a close contact with the heating member 224 to maximise heat transfer between the heating element 220 and the article 110.

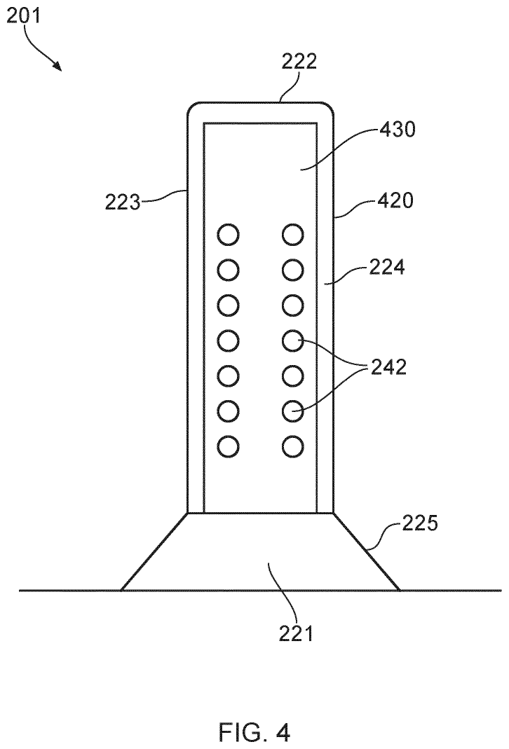

The free end 222 in the present embodiment is blunt. Referring to FIG. 4, in embodiments, the bore 113 in the article 110 is omitted. In embodiments the outer dimensions of the heating element are greater than those of the bore. In such arrangements, the heating element is configured to deform and/or distend the article 110 to be inserted into the article 110. To facilitate this, the inner heating element 220 is configured to pierce an article 110 that is inserted into the device 101. In such an embodiment, the free end 222 of the heating element 220 comprises a sharp edge or point. The free end 222 of the heating element 220 in embodiments comprises a sharp edge, point or other guide feature to aid location of the heating element 220 in the article 110.

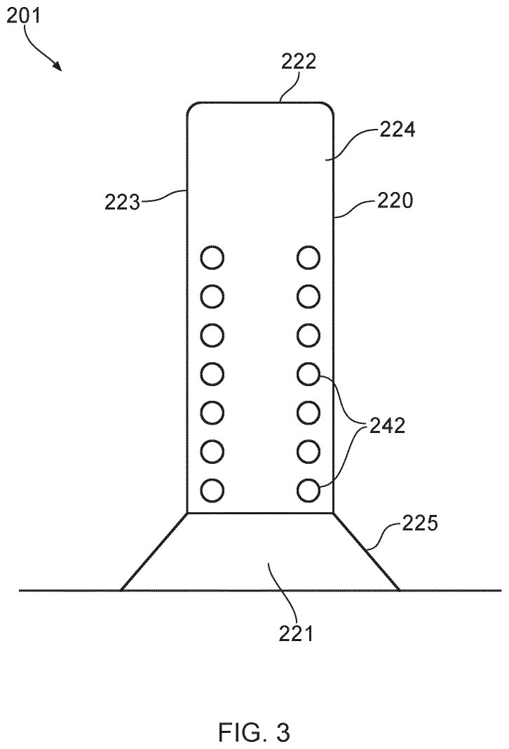

FIG. 3 illustrates a close-up view of the heating arrangement 201. In this embodiment, the inductor coil 242 of the magnetic field generator 240 is disposed within the heating element 220. Providing a heating arrangement 201, wherein an inductor coil 242 is located within an inner heating element 220, which acts as a susceptor, aids with enabling a significant reduction in device size as compared with known devices. A reduction in size requirements of the device 101 due to the heating arrangement 201 provides, for example, greater portability and compactness, increased battery capacity in equally-sized devices and/or a larger heating zone 215 to accommodate larger articles 110. In some embodiments, the inductor coil 242 is completely encased by the material from which the heating element 220 is formed.

The heating element 220 comprises a heating material configured to generate heat in the presence of a varying magnetic field. The heating member 224 is formed from the heating material. The heating member 224 acts as the susceptor. In embodiments, the heating member 224 comprises a layer of heating material, for example forming an outer surface of the heating element. The coil 242 comprises a coating to electrically isolate the coil 242 from the heating material, and to electrically isolate adjacent turns of the coil 242. The coating acts as an insulator. In operation, a varying current is passed through the inductor coil 242. This varying current produces a varying magnetic field in the region of the heating element 220 which causes the heating material in this region to increase in temperature. The heating caused by this magnetic field in the heating material heats the heating element, which transfers heat to the article 110, thereby aerosolizing material in the article 110.

FIG. 4 illustrates another arrangement of the heating arrangement 201 of the device 101. As shown in the figure, the heating element 220 in this instance comprises a heating member 420. The heating member 420 comprises a cavity 430. In this embodiment, the coil 242 is at least partially located within said cavity 430. The cavity 430 may take any shape, and may either completely contain the coil 242 or contact and/or partially encase windings of the coil. The cavity 430 is fluidly isolated from the heating zone 215. Providing an arrangement with a cavity 430 in the heating member 420 housing the coil 242 helps improve reliability of the device 101 by isolating the coil from condensate and/or detritus that can build up in the heating zone 215. The heating element 220 illustrated in each of the figures is generally represented as being cylindrical or tubular in shape. However, heating element 220 may take any form or shape. Consequently, the coil may be a helical coil or any other coil formation capable of generating a magnetic field, such as a flat spiral coil or an ovular coil. The form of the coil is, in embodiments, independent from the choice of form or shape of the heating element.

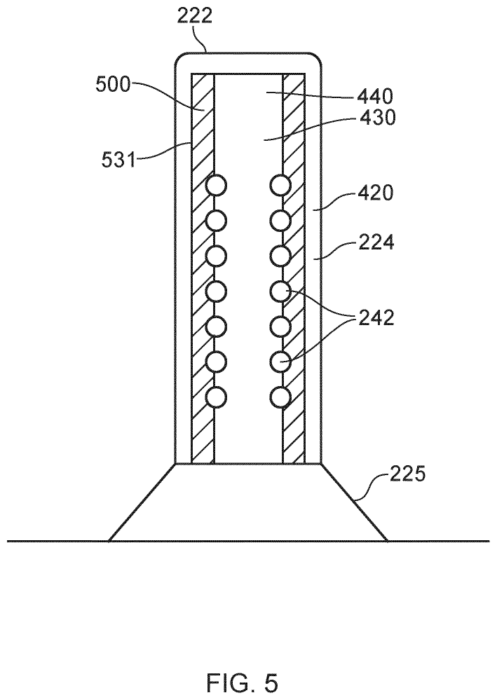

The heating element 220 comprises a carrier (not shown) to support the coil 242 in the cavity 430. The carrier maintains the coil windings in position. One such carrier is shown in FIG. 5. The carrier may be omitted, for example the coil 242 may be self-supportive. In embodiments, the coil 242 is bonded to the heating element 220. In such embodiments, an insulating layer or coating is provided.

FIG. 5 shows another arrangement similar to that of FIG. 4. As in the embodiment of FIG. 4, the heating element 220 comprises a heating member 420 comprising a cavity 430. In this embodiment, the inductor coil 242 is contained within the cavity 430. An electrical insulator 500 is positioned in the cavity 430 of the heating member 420. In this embodiment, the insulator 500 is positioned between the windings of the inductor coil 242 and the wall 531 of the cavity. The insulator 500 acts as a support. Although the cavity wall at the free end 222 is not shown with insulator 500, the insulator 500 may also be positioned along this portion of the cavity wall 531. The free end 222 forms a closed end of the heating element 220. The insulator 500 may comprise a thermal putty or a resin. The insulator 500 in embodiments is a plastic, for example PEEK. The provision of the insulator 500 in this embodiment serves to electrically insulate the coil 242 from the heating member 420. This prevents the heating member 420 from conducting electricity passed through the coil 242. The insulator 500 in this embodiment also helps to support the coil 242 in position within the cavity 430 relative to the heating member 420. A thermally conductive insulator 500 may be used which aids in the heat distribution in the heating element. The space in the heating element 220 not filled with insulator 500 or the coil forms a chamber 440, which may be filled with air. The air in the chamber 440 may act to convect heat along the heating element 220. The provision of such an air filled chamber 440 may also distribute the heat in the heating element 220 around the edges thereof proximate the article 110 in use, so as to improve heating of the material in the article 110.

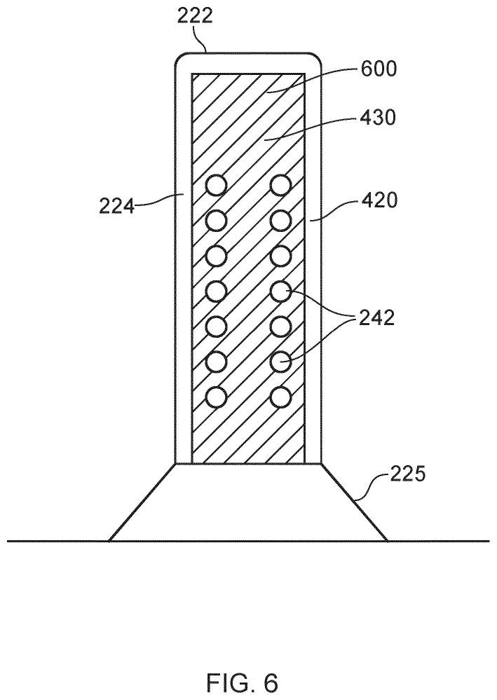

FIG. 6 shows another arrangement of the heating arrangement 201. In this embodiment, an insulator 600, similar to the insulator 500 of FIG. 5, fills the cavity 430 around the coil 242. The provision of insulator 600 supports the coil 242 in position relative to the heating member, ensuring reliability and longevity of the device. The insulator 600 may be formed from a thermal conductor such as a thermal putty. The use of a thermal putty as the insulator 600 would improve distribution of heat in the heating member, providing a more effective aerosolization of the article in use.

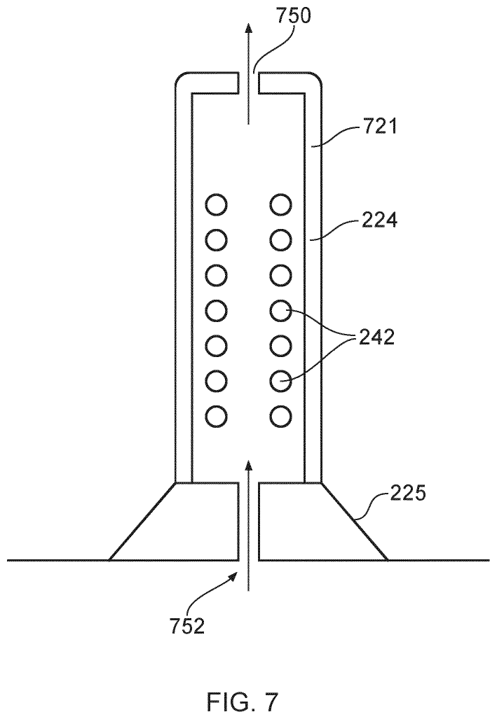

FIG. 7 illustrates a further embodiment. In this embodiment, the heating member 420 is provided with an air outlet 750 through its wall 721. Also illustrated is air inlet 752 through the base of the heating element 220. Generally, the air inlet 752 is in fluid communication with a passage (not shown) in communication with an exterior of the device 101. In use, when a user draws on the mouthpiece of the device 101, air enters the device 101, and the heating element 220 through the air inlet 752, and travels through the cavity 430 of the heating member 420 out through the air outlet 750. The air then passes through the heated aerosol-generating material in the inserted article, providing aerosolized material to the user. Although the air inlet 752 is shown in FIG. 7 to be located in the base of the heating element 220, the air inlet 752 may be located at any position on the heating element 220. Similarly, the air outlet 750 may be positioned at any location on the heating element 220. Although only one air inlet 752 and air outlet 750 are shown, the heating element 220 may comprise any number of air inlets 752 and air outlets 750. The heating element 220 may comprise a perforated heating member 420. One of the advantages of providing an air conduit through the cavity 430 and past the coil 242 is that the operation of the device 101, in which air is drawn in contact with the coil, provides cooling of the coil 242 by drawn-in air. This reduces undesired resistive heating losses in the coil 242, thereby improving overall efficiency of the device and prolonging battery life. The embodiment shown in FIG. 7 and as described above may be combined with any previously described embodiment of any of FIGS. 1 to 6. This means that any of the described embodiments may be provided with at least one air inlet 752 and air outlet 750 through the heating element 220.

The wall 721 of the heating member 420 in any of the embodiments described in relation to FIGS. 4 to 7 may comprise a heating material configured to generate heat in the presence of a varying magnetic field. The heating member 420 may consist of said heating material, or may further comprise a supporting layer positioned externally or internally of the heating member 420. The heating member 420 may further comprise a protective outer coating positioned on its exterior surface. Said outer coating may be thermally conductive so as not to hinder the heating of the aerosol-generating material.

In any of the aforementioned embodiments, the coil 242 may comprise a coating on its outer surface to protect the coil 242 from oxidisation and prevent electrical contact between adjacent coil windings and the heating member 420. Such coatings may comprise enamel.

In any of the abovementioned embodiments, the coil 242 may be spaced from the heating member 224 and/or heating material. The coil 242 may be spaced from the heating member 224 and/or heating material by between 0.1 mm and 0.2 mm. This means that the distance between the outer circumference of the coil 242 may be a distance of between 0.1 mm and 0.2 mm from the inner surface of the heating member 224 and/or the heating material present in the heating member 224. In some embodiments, the distance between the outer circumference of the coil 242 and the inner surface of the heating member 224 and/or heating material may be less than 0.2 mm. The inductor coil 242 may be a helical coil and the inner volume of the heating member defined by the cavity 430 may be generally cylindrical. The heating member 224 may be tubular. In such embodiments, the spacing between the outer circumference of the coil 242 and the inner surface of the heating member 224 and/or heating material may be constant around the circumference of the coil 242.

In some embodiments, the internal diameter of the coil 242 is between 1 mm and 1.5 mm. In some embodiments, the outer diameter of the coil 242 is between 2 mm and 2.5 mm. The coil 242 may be helical in these embodiments.

In some embodiments, the cross-sectional diameter of the windings of the coil may be between 0.5 mm and 0.75 mm.

In any of the herein described embodiments, the magnetic field generator 240 may be configured to generate a varying magnetic field having a frequency of from 800 kHz to 1.5 MHz.

In some embodiments, as generally shown in the figures, the inductor coil 242 extends partially along the length of the heating element 220, starting from the end proximate the collar 225. However, any of the aforementioned embodiments may also comprise a coil 242 which extends fully along the length of the heating element 220. The coil may also extend partially along the heating element 220 but not starting at the end proximate the collar. For example, the coil 242 could extend from the free end 222 of the heating element 220. The coil 242 may extend across any selected length of the heating element 220 so as to provide a specific heating profile. The positioning and extension of the coil 242 may offer localised heating to the heating element 220 and therefore to the article 110 along particular areas of the heating element 220 and article 110. If the coil 242 extends along the full length of the heating element 220, this ensures consistent heating along the entire length of the heating element 220 and provides an increase in overall heat provided to the article 110.

FIG. 8 shows another embodiment. The embodiment of FIG. 8 corresponds generally to that of FIG. 2, except that the heating element 220 protrudes from the housing 103. In such an embodiment, the device is free from a receptacle in which the heating element is received. That is, the heating zone 215 is free from being surrounded or delimited by any other component.

Any of the heating elements of FIGS. 3 to 7 may be used in the aerosol generating device of FIG. 8. The inductor coil in embodiments is at least in part in the heating element corresponding to the arrangements described above. The inductor coil at least partially extends in the heating zone. The heating arrangement in embodiments is an inductive heating arrangement. The heating arrangement in embodiments is a resistive heating arrangement. In embodiments, a resistive heating element is used in the device of FIG. 8. In such arrangements the heating assembly 201 comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

The housing 103 defines the base 213a from which the heating element 220 protrudes. The heating element 220 upstands from the base 213a. The heating element 220 is configured to receive at least a portion of the article 110. The heating element 220 is exposed. The term ‘exposed’ will be understood to mean that a portion of a feature is not surrounded by another feature such that the feature extends beyond an external extent. The heating element 220 is not received in a heating chamber. With the device of FIG. 8, the heating element extends beyond an external extent of the housing of the device. In the embodiment of FIG. 8, the entire heating element 220 protruding from the base is free from being surrounded. In embodiments, a substantial portion of the heating element 220 is exposed. In such an embodiment, a minor portion of the heating element extends within the external extent of the housing of the device. Optionally, at least 80% of the heating element 220 is exposed, optionally 60%, and optionally 50%.

FIG. 8 also shows an article 110 for use with any of the embodiments described herein. The article 110 of FIG. 8 is generally the same as the article 110 of FIG. 2. The article 110 of FIG. 8 may be used with the aerosol generating device 101 of FIG. 8. The article 110 comprises the bore 113. The bore 113 may be omitted. The exposed heating element of FIG. 8 provides a lighter and more compact device and facilitates access to the heating element for cleaning.

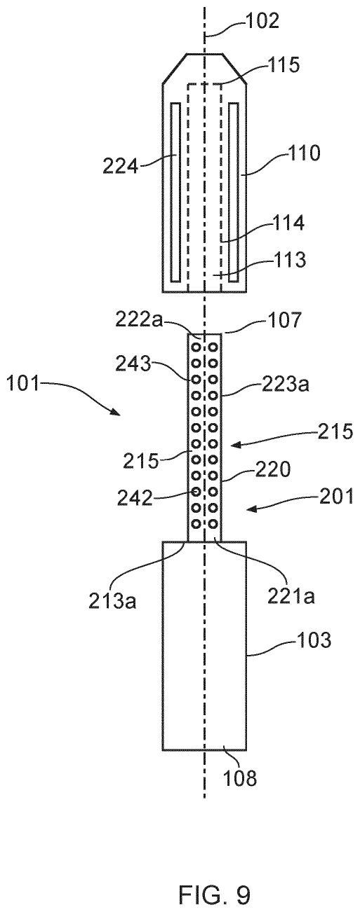

FIG. 9 shows another embodiment. The embodiment of FIG. 9 corresponds generally to that of FIG. 8, except that the device 101 does not comprise a heating element 220. In the embodiments described above the heating element 220 acts as a protruding element. In the embodiments described with reference to FIG. 9, the device comprises a protruding element 243 and the article 110 comprises a heating element. The protruding element 243 comprises an inductor coil 242.

In such an embodiment, the device is free from a receptacle in which the heating element is received. That is, the heating zone 215 is free from being surrounded or delimited by any other component. The housing 103 defines the base 213a from which the protruding element 243 protrudes. The protruding element 243 upstands from the base 213a. The protruding element 243 is configured to receive at least a portion of the article 110. The protruding element 243 is exposed. The term ‘exposed’ will be understood to mean that a portion of a feature is not surrounded by another feature such that the feature extends beyond an external extent. The protruding element 243 is not received in a heating chamber. With the device of FIG. 9, the protruding element 243 extends beyond an external extent of the housing 103 of the device 101. In the embodiment of FIG. 9, the entire protruding element 243 protruding from the base is free from being surrounded. In embodiments, a substantial portion of the protruding element 243 is exposed. In such an embodiment, a minor portion of the protruding element 243 extends within the external extent of the housing 103 of the device 101. Optionally, at least 80% of the protruding element 243 is exposed, optionally 60%, and optionally 50%.

The protruding element 243 is positioned, in use, within the article 110.

The protruding element 243 is a pin or column. The protruding element acts as a rod. The protruding element is elongate. Other shapes are envisaged, for example the heating member in embodiments is a blade.

The protruding element 243 extends from the proximal end of the housing 103 along the longitudinal axis 102 of the device (in the axial direction). In embodiments the protruding element 243 extends spaced from the axis 102. The protruding element 243 may be off-axis or non-parallel to the axis 102. Although one protruding element 243 is shown, it will be understood that in embodiments, the device 101 comprises a plurality of protruding elements 243. Such protruding elements in embodiments are spaced from but parallel to each other.

The protruding element 243 upstands from the end wall 213a of the housing 103. The protruding element 243 comprises a base end 221a and an opposing free end 222a. The protruding element 243 is a pin or column. Other shapes are envisaged, for example the protruding element 243 in embodiments is a blade.

The protruding element 243 comprises an outer surface 223a. The outer surface 223a defines a periphery of the protruding element 243. The outer surface 223a extends between the base end 221a and the free end 222a. The protruding element 243 is generally cylindrical although other shapes are envisaged.

The article 110 comprises a bore 113. The bore 113 is pre-formed in the article 110. The bore 113 is formed in embodiments by a tubular portion of the article 110. The bore 113 in embodiments extends partially along the longitudinal axis of the article. The bore 113 comprises an inner surface 114. The bore 113 has a closed end 115. The protruding element 224 is sized to be received in the bore 113. The protruding element 243 and bore 113 are complimentary sized to form a slide fit. The inner surface 114 of the bore is configured to form a close contact with the protruding element 243 to retain the article 110 on the protruding element 243.

The free end 222a in the present embodiment is blunt. Referring to FIG. 9, in embodiments, the bore 113 in the article 110 is omitted. In embodiments the outer dimensions of the protruding element 243 are greater than those of the bore. In such arrangements, the protruding element 243 is configured to deform and/or distend the article 110 to be inserted into the article 110. To facilitate this, the protruding element 243 is configured to pierce an article 110 that is inserted onto the device 101. In such an embodiment, the free end 222a of the protruding element 243 comprises a sharp edge or point. The free end 222a of the protruding element 243 in embodiments comprises a sharp edge, point or other guide feature to aid location of the protruding element 243 in the article 110.

The inductor coil 242 is embedded in the protruding element 243. The protruding element 243 is an electrical insulator. The protruding element 243 protects and supports the inductor coil 242. The protruding element 243 may comprise a thermal putty or a resin. The protruding element 243 in embodiments is a plastic, for example PEEK.

The article 110 comprises a heating member 224, acting as a heating element. The heating member 224 is formed from a heating material configured to generate heat in the presence of a varying magnetic field. The heating member 224 acts as the susceptor. The heating member 224 is tubular. The heating member 224 is positionable around the protruding element 243. The heating member 224 is embedded in the aerosol generating material. In embodiments, the heating member 224 forms a layer or coating on the aerosol generating material. In embodiments, the heating member 224 forms a surface of the bore 113 of the article 110. The heating member 224 comprises a film of heating material. In embodiments, the heating member comprises a plurality of particles of heating material dispersed in the aerosol generating material. In embodiments, the heating member comprises a coil of heating material. Provision of the heating member 224 in the article 110 improves the safety of the device, as the exposed protruding element 243 is not directly heated, reducing the chance of a user sustaining a burn by accidentally contacting the exposed protruding element 243 after use and after removal of the article 110.

In embodiments with an inductive heating arrangement, the protruding element 243 comprises a body, acting as a protruding member, defining the outer extent of the protruding element 243. The body defines the exposed outer surface of the protruding element 243. In embodiments, the body is free from material that is heatable by penetration with a varying magnetic field.

In the above described embodiments, the heating arrangement is an inductive heating arrangement. In embodiments, other types of heating arrangement are used, such as resistive heating. The configuration of the device is generally as described above and so a detailed description will be omitted. In such arrangements the heating assembly 201 comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol generating device for generating an aerosol from aerosol-generating material, the device comprising:
a heating zone for receiving at least a portion of an article comprising aerosol-generating material;
a heating assembly comprising:
a magnetic field generator configured to generate a varying magnetic field including an inductor coil; and
a heating element comprising heating material that is heatable by penetration with the varying magnetic field;
wherein the heating element protrudes in the heating zone; and
wherein the inductor coil at least partially protrudes in the heating zone.

2. The aerosol generating device of claim 1, wherein the inductor coil at least partially extends in the heating element.

3. The aerosol generating device of claim 2, wherein the inductor coil is fluidly isolated from the heating zone.

4. The aerosol generating device of claim 2, wherein the heating element comprises a cavity and the inductor coil at least partially extends in the cavity.

5. The aerosol generating device of claim 4, wherein the cavity is isolated from the heating zone.

6. The aerosol generating device of claim 4 or 5, wherein the cavity at least partially defines an air path through the heating element.

7. The aerosol generating device of claim 4, wherein the heating element comprises a wall and an air outlet communicating through the wall.

8. The aerosol generating device of claim 1, wherein the heating element comprises a heating member and an insulator in the heating member.

9. The aerosol generating device of claim 8, wherein the insulator supports the inductor coil in the heating member.

10. The aerosol generating device of claim 8, wherein the insulator comprises a filler.

11. The aerosol generating device of claim 8, wherein the coil comprises a coating.

12. The aerosol generating device of claim 8, wherein the insulator electrically insulates the coil from the heating member.

13. The aerosol generating device of claim 1, wherein the heating material is spaced from the inductor coil.

14. The aerosol generating device of claim 1, wherein the inductor coil is spaced from the heating material by a distance less than 0.2 mm.

15. (canceled)

16. (canceled)

17. (canceled)

18. The aerosol generating device of claim 1, wherein the heating element is tubular or is a blade.

19. (canceled)

20. The aerosol generating device of claim 1, wherein the inductor coil comprises a coil winding having a cross-sectional diameter between 0.5 mm and 0.75 mm.

21. The aerosol generating device of claim 1, wherein the magnetic field generator is configured to generate a varying magnetic field at a frequency of from 800 kHz to 1.5 MHz.

22. (canceled)

23. (canceled)

24. A heating assembly for an aerosol generating device, the assembly comprising:
an inductor coil for a magnetic field generator configured to generate a varying magnetic field; and
a heating element arranged to extend in a heating zone of an aerosol generating device, the heating element comprising heating material that is heatable by penetration with the varying magnetic field;
wherein the inductor coil at least partially extends in the heating element.

25. A system comprising the aerosol generating device of claim 1, and an article comprising aerosol-generating material.

26. (canceled)

27. (canceled)

28. (canceled)

29. (canceled)

30. An aerosol generating device for generating an aerosol from aerosol-generating material, the device comprising:
a housing;
an exposed heating arrangement protruding from the housing configured to be received within an aerosol-generating article and heat the aerosol-generating article.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)
